(19) United States
(12) Patent Application Publication
(10) Pub. No.: US 2009/0091492 A1
(43) Pub. Date: Apr. 9, 2009

(54) Detection and mitigation radio frequency memory (DRFM)-based interference in synthetic aperture radar (SAR) images

(75) Inventors: Probal Kumar Sanyal, Syracuse, NY (US); Richard Prather Perry, Amherst, NH (US); David Matthew Zasada, Taberg, NY (US)

Correspondence Address: STERNE, KESSLER, GOLDSTEIN & FOX P.L.L.C., 1100 NEW YORK AVENUE, N.W., WASHINGTON, DC, 20005, US

(73) Assignee: The MITRE Corporation, McLean, VA (US)

(21) Appl. No.: 11/907,096

(22) Filed: Oct. 9, 2007

(51) Int. Cl. G01S 13/90

(52) U.S. Cl. 342/25 C

(57) ABSTRACT

Methods and systems for detecting and mitigating DRFM-based interference in SAR images are provided. Embodiments include methods and systems for detecting and removing DRFM-based interference from SAR images by exploiting multi-channel SAR data. Embodiments provide an Electronic Counter Counter Measure (ECCM) technique that is effective against, among others, SAR DRFM-based repeater jamming, false target images, noise jamming, and vector multiplier jamming for false scene generation. When used, embodiments of the present invention reduce jammer effectiveness to a small range strip (a strip parallel to the range dimension) in the direction of the jammer. In addition, jammer mitigation is performed without losing SAR image data at the affected SAR pixels. Furthermore, embodiments of are compatible with time variable ECCM techniques, including orthogonal waveforms or pulse jitter techniques, for example.

### FIELD OF THE INVENTION

The present invention relates to methods and systems for detecting and mitigating DRFM-based interference in SAR images.

### BACKGROUND OF THE INVENTION

The exploitation of Synthetic Aperture Radar (SAR) images for surveillance is an important function within several applications. Consequently, the contamination of SAR images by intentional or unintentional interference is a great concern.

Digital Radio Frequency Memory (DRFM)-based interference is caused by repeater interfering signals generated by DRFMs. DRFMs operate by recording signals transmitted by a radar and re-transmitting delayed and modulated versions of these signals toward the radar. The effect of these re-transmitted signals includes false targets that appear at several cross range locations within the radar image. For example, bright spots, which generally appear displaced relative to the locations of their respective DRFM sources, appear on the radar image. These bright spots can also be made to appear through modulation at specific locations in order to cover certain targets within the radar image.

There is a need therefore for a system and method for removing DRFM-based interference from SAR images.

### BRIEF SUMMARY OF THE INVENTION

Embodiments of the present invention include methods and systems for detecting and mitigating DRFM-based interference in SAR images. More particularly, embodiments include methods and systems for detecting and removing DRFM-based interference from SAR images by exploiting multi-channel SAR data.

Embodiments of the present invention provide an Electronic Counter Counter Measure (ECCM) technique that is effective against, among others, SAR DRFM-based repeater jamming, false target images, noise jamming, and vector multiplier jamming for false scene generation. When used, embodiments of the present invention reduce jammer effectiveness to a small range strip (a strip parallel to the range dimension) in the direction of the jammer. In addition, jammer mitigation is performed without losing SAR image data at the affected SAR pixels. Furthermore, embodiments of the present invention are compatible with time variable ECCM techniques, including orthogonal waveforms or pulse jitter techniques, for example.

Further features and advantages of the present invention, as well as the structure and operation of various embodiments thereof, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is an example embodiment of a system for removing interference from radar images according to an embodiment of the present invention.

FIG. 2 is an example embodiment of the processing module of the system of FIG. 1 according to an embodiment of the present invention.

FIG. 3 is a process flowchart of a method for removing interference from radar images according to an embodiment of the present invention.

FIG. 4 is an example radar ground image of a geographical area.

FIG. 5 is an example radar ground image of the geographical area of FIG. 4 with DRFM-based interference from a first phase center of a radar.

FIG. 6 is an example radar ground image of the geographical area of FIG. 4 with DRFM-based interference from a second phase center of the radar.

FIG. 7 is an example radar ground image of the geographical area of FIG. 4 with DRFM-based interference from a third phase center of the radar.

FIG. 8 is an example radar image with ground return cancelled generated based on the radar ground images of FIGS. 5 and 6.

FIG. 9 is an example radar image with DRFM-based interference cancelled.

FIG. 10 illustrates the effectiveness of DRFM-based interference detection and mitigation according to an embodiment of the present invention.

The features and advantages of the present invention will become more apparent from the detailed description set forth below when taken in conjunction with the drawings. In the drawings, like reference numbers generally indicate identical, functionally similar, and/or structurally similar elements. Generally, the drawing in which an element first appears is indicated by the leftmost digit(s) in the corresponding reference number.

### DETAILED DESCRIPTION OF THE INVENTION

Conventional usage of SAR images is based on single-channel SAR data. As such, the ability to detect changes and/or interference in SAR images is limited. For example, in the context of detecting moving targets, frame-to-frame coherent change detection methods are used.

With the advent of multi-channel SAR systems, more powerful uses of SAR data can be envisioned. For example, multi-channel SAR data has been used to efficiently detect moving targets using phase interferometry. Further detail of this detection approach can be found in commonly owned U.S. patent application Ser. No. 11/300,381, filed Dec. 15, 2005, titled “System and Method for Monitoring Targets,” incorporated herein by reference in its entirety.

Digital Radio Frequency Memory (DRFM)-based interference is caused by repeater interfering signals generated by DRFMs. DRFMs operate by recording signals transmitted by a radar and re-transmitting delayed and modulated versions of these signals toward the radar. The effect of these re-transmitted signals includes false targets that appear at several cross range locations within the radar image. For example, bright spots, which generally appear displaced relative to the locations of their respective DRFM sources, appear on the radar image. These bright spots can also be made to appear through modulation at specific locations in order to cover certain targets within the radar image.

Interestingly, the false targets caused by DRFMs behave similarly to moving targets in SAR images. As such, they also appear as anomalies when a phase difference image is generated from two or more SAR images.

The present invention relates to methods and systems for detecting and mitigating DRFM-based interference in SAR images. More particularly, embodiments include methods and systems for detecting and removing DRFM-based interference from SAR images by exploiting multi-channel SAR data.

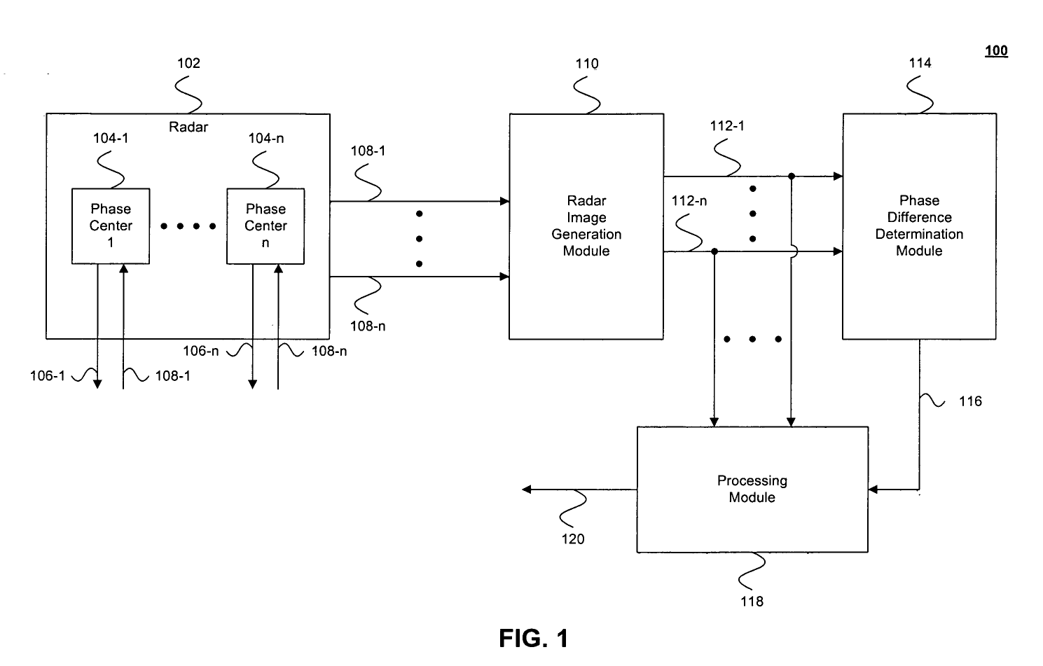

FIG. 1 is an example embodiment of a system 100 for removing interference from radar images. In an embodiment, system 100 can be used to remove DRFM-based interference from SAR images.

System 100 includes a radar 102, a radar image generation module 110, a phase difference determination module 114, and a processing module 118.

Radar 102 may be a SAR. Radar 102 includes a plurality of phase centers 104-1 to 104-n, as shown in FIG. 1. Phase centers 104-1 to 104-n may be located at spatially different points within radar 102. Phase centers 104-1 to 104-n each operates by transmitting a signal 106 toward a target location (e.g., geographic region) and receiving a corresponding return signal 108. Return signals 108-1 to 108-n contain information characteristic of the target, each from a different direction depending on the spatial location of the receiving phase center.

Radar image generation module 110 receives return signals 108-1 to 108-n from radar 102 and transforms the received return signals into corresponding radar images 112-1 to 112-n. In an embodiment, radar image generation module 110 generates SAR images from the received return signals.

Subsequently, radar image generation module 110 forwards the generated radar images 112-1 to 112-n to phase difference determination module 114. Also, radar image generation module 110 forward radar images 112-1 to 112-n to processing module 118.

Phase difference determination module 114 uses two or more of radar images 112-1 to 112-n to generate a phase difference image 116. In an embodiment, phase difference image 116 is generated by phase differencing two radar images from radar images 112-1 to 112-n. In other embodiments, phase difference image 116 is generated by averaging the resulting phase difference images generated from multiple image pairs, thereby resulting in a better estimate of phase difference image 116. In an embodiment, phase difference determination module 114 includes a phase-interferometer. Phase difference determination module 114 forwards phase difference image 116 to processing module 118.

Processing module 118 receives phase difference image 116 and radar images 112-1 to 112-n and processes the received images to generate an interference-free radar image 120. In an embodiment, interference-free radar image 120 includes minimal or no interference, including DRFM-based interference.

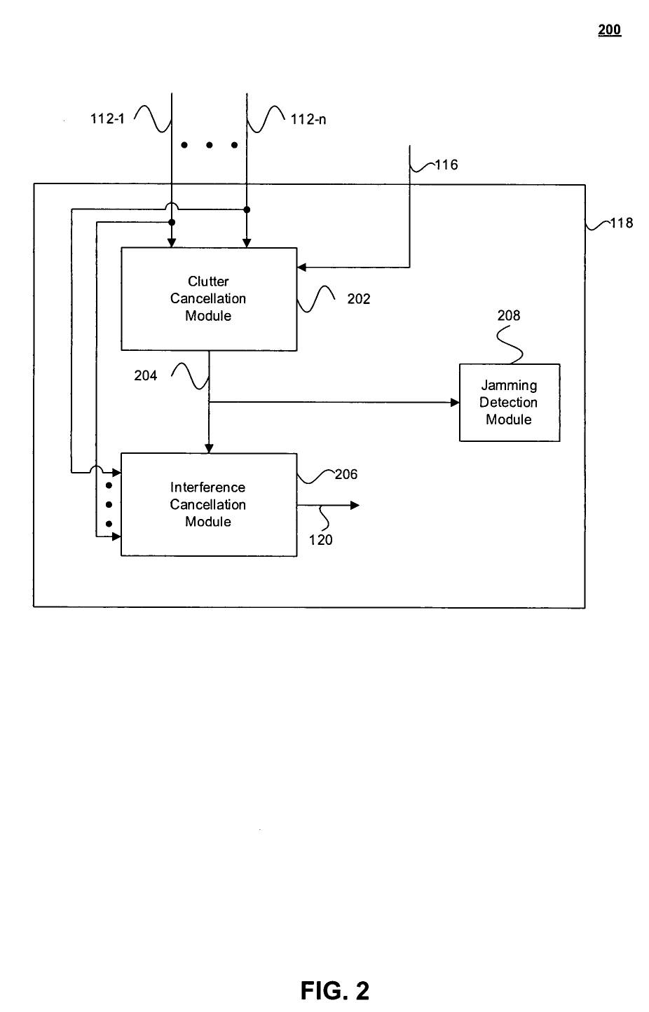

FIG. 2 is an example embodiment 200 of processing module 118 of system 100. As shown, processing module 118 includes a clutter-cancellation module 202 and an interference cancellation module 206.

Clutter cancellation module 202 performs a cancellation of the ground return to generate radar images that contain only or nearly only the return due to interfering signals. As such, clutter cancellation module 202 receives radar images 112-1 to 112-n from radar image generation module 110 and phase difference image 116 determination module 114. Clutter cancellation module 202 then uses any two of received radar images 112-1 to 112-n and phase difference image 116 to generate clutter-cancelled images 204. In an embodiment, clutter-cancelled images 204 include minimal or no ground returns.

Subsequently, clutter-cancelled images 204 are input into interference cancellation module 206 together with radar images 112-1 to 112-n to generate interference-free radar image 120. In an embodiment, interference cancellation module 206 generates a phase difference image from a pair of clutter cancelled images, which is used in combining radar images 112-1 to 112-n to generate an interference image 120.

Optionally, processing module 118 includes a jamming detection module 208, which can be used to detect whether jamming is present. In an embodiment, jamming detection module 118 operates by examining the phases associated with pixels of clutter-cancelled radar image 204.

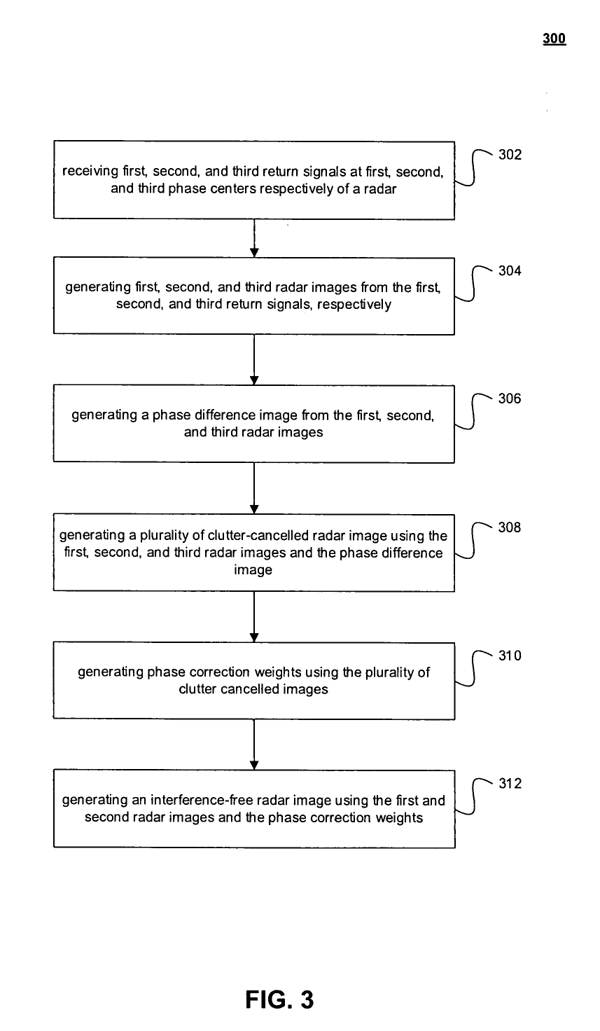

FIG. 3 is a process flowchart 300 of a method for removing interference from radar images according to an embodiment of the present invention. Process 300 can be used with SAR images, for example, to remove, among other types of interference, DRFM-based interference. Process 300 begins in step 302, which includes receiving first, second, and third return signals at first, second, and third phase centers respectively of a radar. In an embodiment, the first, second, and third return signals are in response to first, second and third signals transmitted from the phase centers of the radar.

Step 304 includes generating first, second, and third radar images from the first, second, and third return signals, respectively.

Step 306 includes generating a phase difference image from the first, second, and third radar images. In an embodiment, the phase difference image is generated from the first and second radar images. In an embodiment, step 306 includes generating a phase-interferometry image.

Step 308 includes generating a plurality of clutter-cancelled radar images using the first, second, and third radar images and the phase difference image. In an embodiment, a first clutter-cancelled image is generated using the first and second radar images and the phase difference image, and a second clutter-cancelled image is generated from the second and third radar images and the phase difference image. The clutter-cancelled radar images include minimal or no ground return. In an embodiment, step 308 includes estimating for each pixel of the phase-interferometry image a corresponding smoothed value of the phase difference for the pixel between the first and second radar images; and subtracting for each pixel the second radar image, modified by its corresponding smoothed value, from the first radar image to generate the first clutter-cancelled image. The same process is performed using the second and third radar images to generate the second clutter-cancelled image. In another embodiment, step 308 further includes fitting a least-square-error (LSE) plane to the phase-interferometry image.

Step 310 includes generating phase correction weights using the plurality of clutter-cancelled images. In an embodiment, step 310 includes generating a clutter-cancelled phase difference image using the plurality of clutter-cancelled images. For example, the clutter-cancelled phase difference image is generated using the first and second clutter-cancelled radar images.

Step 312 includes generating an interference-free radar image using the first and second radar images and the phase correction weights. In an embodiment, the clutter-cancelled phase difference image is used to modify the second radar image before subtracting it from the first radar image to generate the interference-free image. The interference-free radar image includes minimal or no Digital Radio Frequency Memory (DRFM)-based interference.

As would be understood by a person skilled in the art based on the teachings herein, the above described process can also be performed using more or less than three radar images. For example, an interference-free radar image can be generated starting from two radar images and by generating a single clutter-cancelled image.

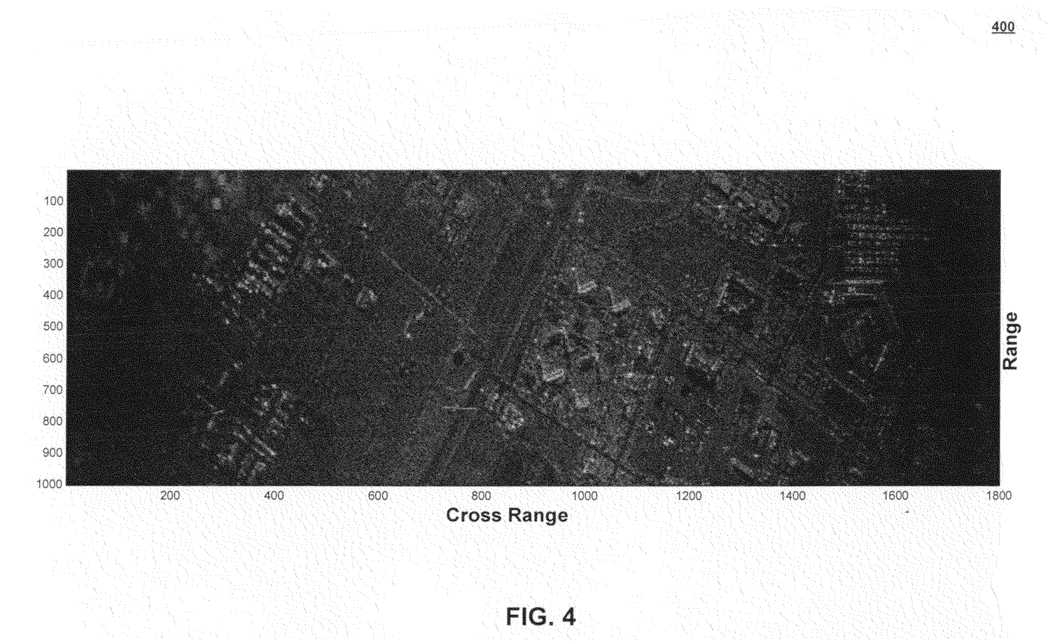

FIGS. 4-9 illustrate an example of DRFM-based interference removal from a SAR image according to an embodiment of the present invention.

FIG. 4 is an example radar ground image 400 of a given geographical area. No or minimal interference is present in radar ground image 400. Accordingly, as shown, several features (e.g., buildings, roads, etc.) can be readily recognized from radar ground image 400. Radar ground image 400 may have been generated from signals received by a given phase center of a multi-phase center radar such as radar 102, for example.

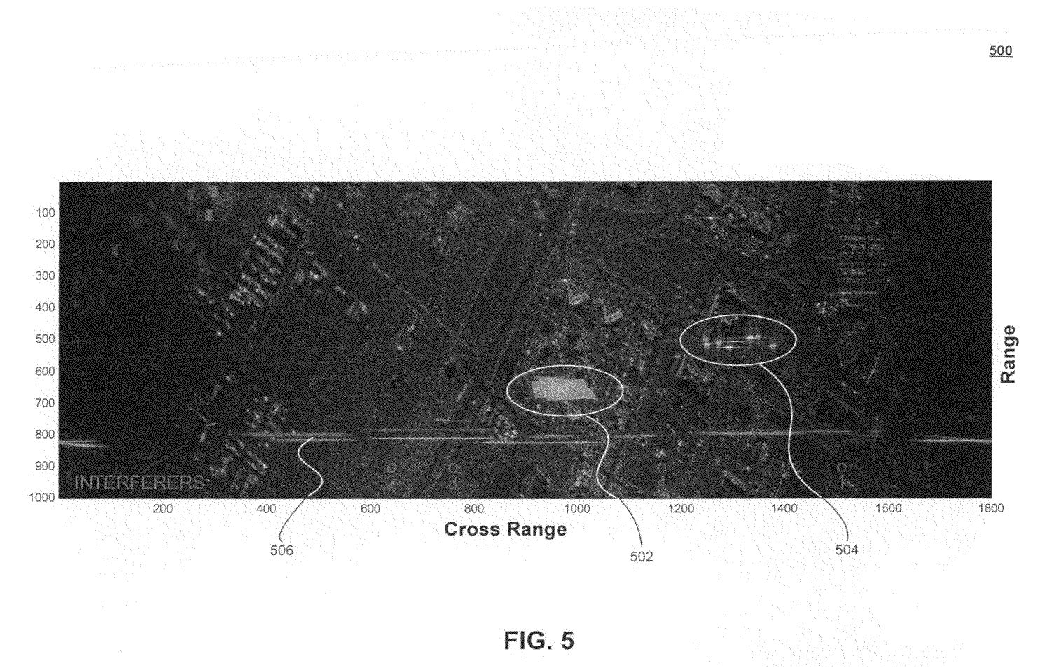

FIG. 5 is an example radar ground image 500 of the same geographical area as shown in FIG. 4, generated from a first phase center of a multi-phase center radar. DRFM-based interference is present in radar ground image 500 and causes bright spots to appear at different locations within radar ground image 500, as illustrated by reference numbers 502 and 504. As shown, the bright spots, 502 and 504, hide certain features of the geographical area. Other anomalies, as illustrated by reference number 506, also appear in radar ground image 500 and may be due to moving objects, for example.

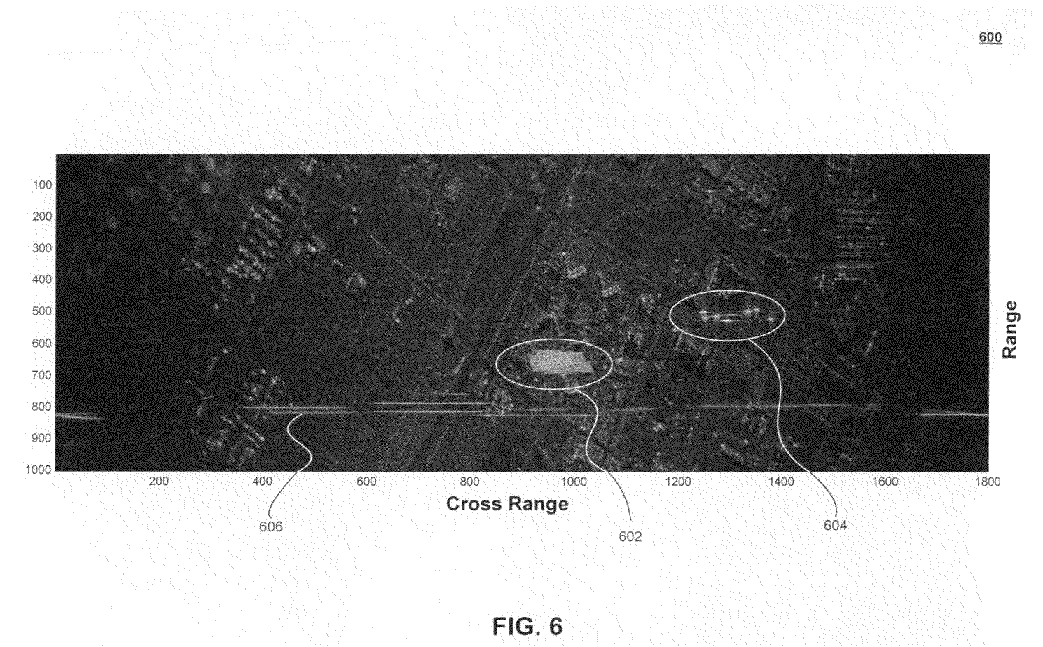

FIG. 6 is an example radar ground image 600 of the same geographical area as shown in FIG. 4, generated from a second phase center of the multi-phase center radar. As with radar ground image 500, DRFM-based interference is present in radar ground image 600, as illustrated by reference numbers 602 and 604. Other anomalies, illustrated by reference number 506, also appear in radar ground image 600.

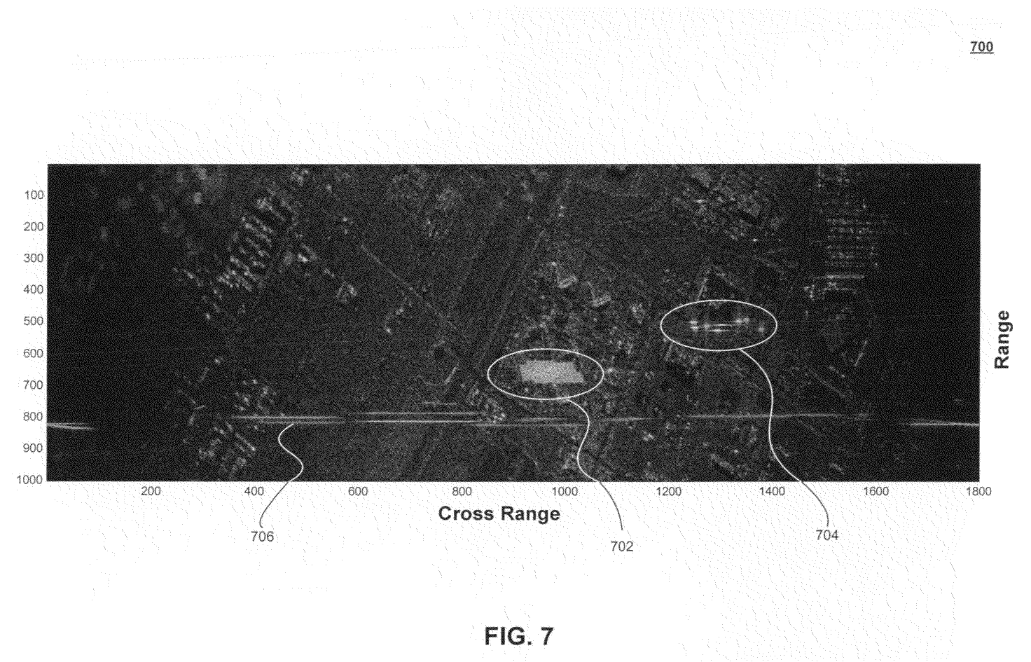

FIG. 7 is an example radar ground image 700 of the same geographical area as shown in FIG. 4, generated from a third phase center of the multi-phase center radar. DRFM-based interference, as illustrated by reference numbers 702 and 704, and other anomalies 706 (e.g., moving objects) are also present in radar ground image 700.

Note that images 500, 600, and 700 do not appear different to the naked eye. However, differences between the images lie in the underlying phase information, which is not displayed.

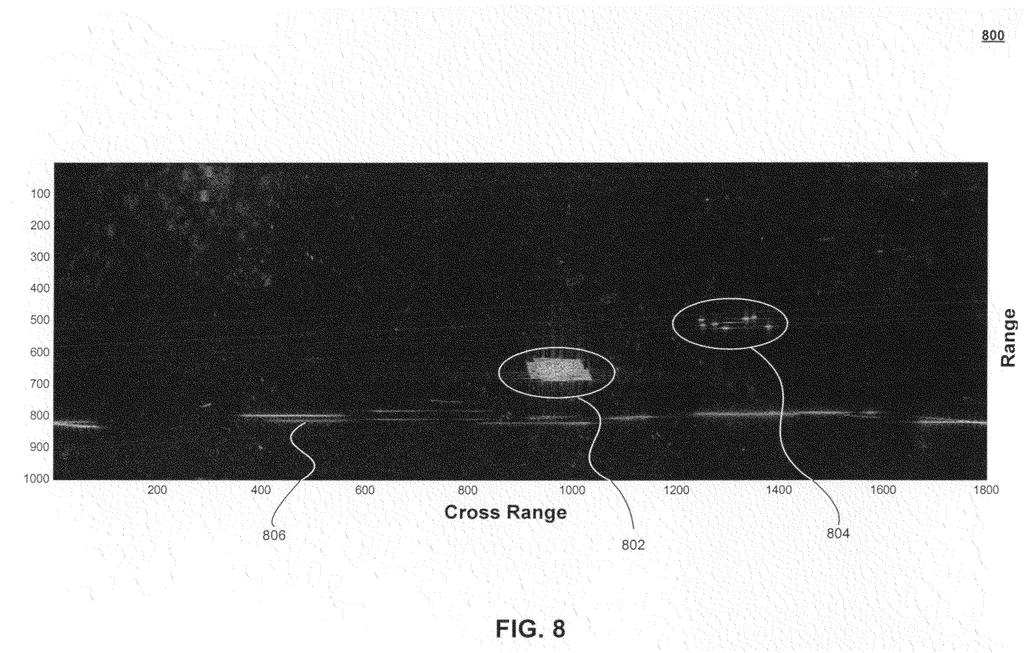

FIG. 8 is an example radar image 800 with ground return cancelled. In other words, radar image 800 is a clutter-cancelled radar image. Radar image 800 is generated using radar images 500 and 600 and a phase difference image generated from radar images 500 and 600. As shown, all return signals due to ground, including signals due to features that appear in radar ground image 400, are substantially cancelled in radar image 800. Return signals due to interferers, however, including DRFM signals and signals due to moving objects, remain present in radar image 800, as illustrated by reference numbers 802, 804, and 806.

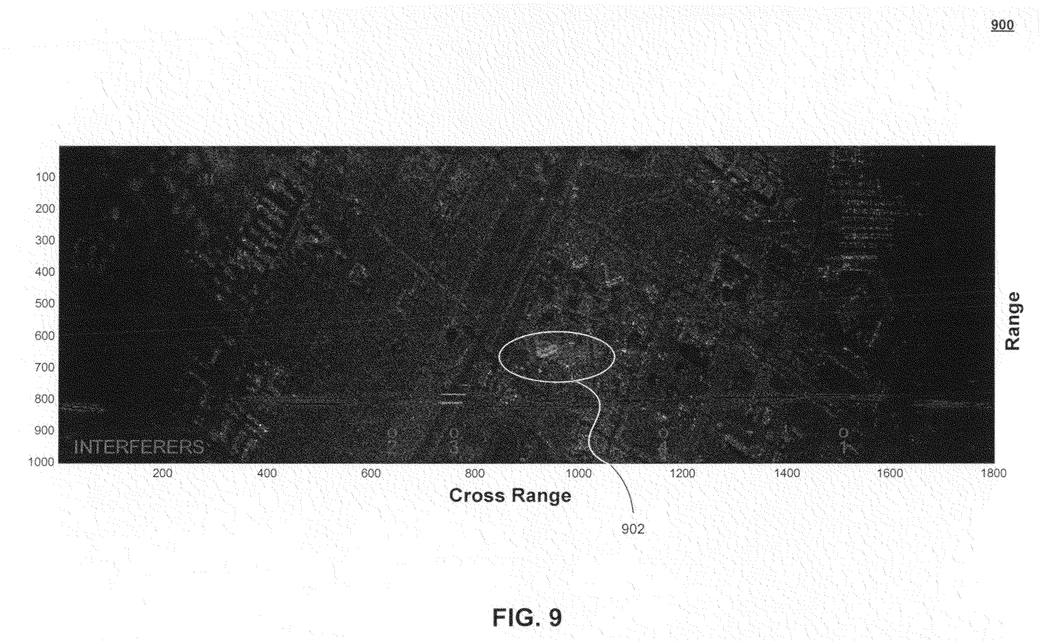

FIG. 9 is an example radar image 900, with DRFM-based interference substantially cancelled according to an embodiment of the present invention. Radar image 900 may be generated using example radar image 800 and any one of radar images 500 and 600. For example, radar image 900 may be generated by subtracting radar image 800 from radar image 500. As shown, the effects of DRFM-based interference, illustrated by reference number 902, are greatly diminished in radar image 900, compared to radar images 500, 600, and 700, for example. Radar image 900, as such, includes no or minimal DRFM-based interference.

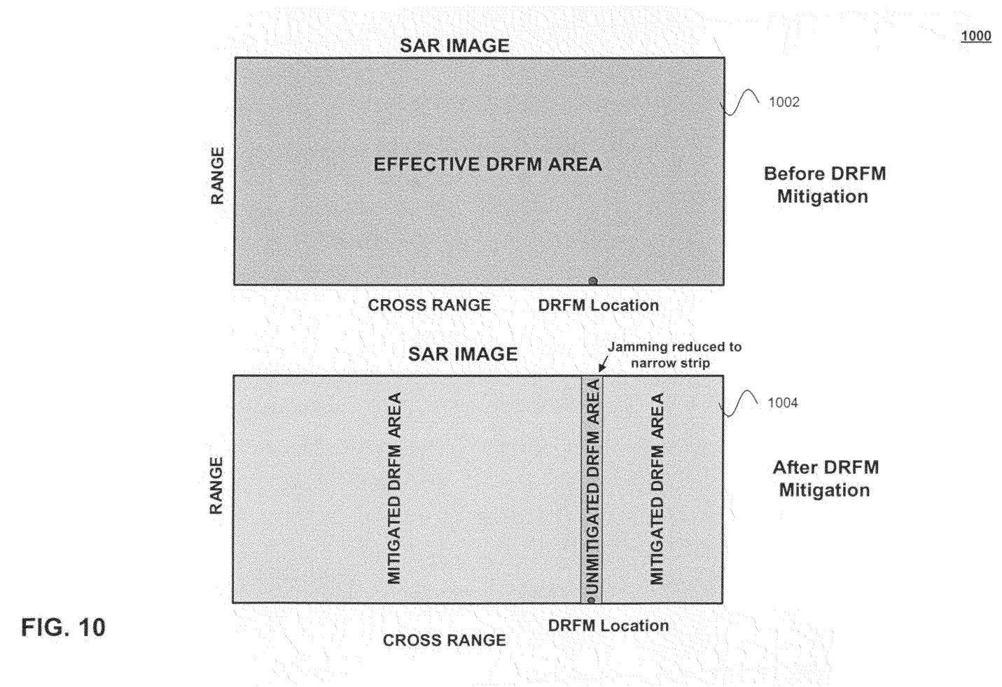

FIG. 10 is an example 1000 that illustrates the effectiveness of DFRM-based interference detection and mitigation according to an embodiment of the present invention. SAR image area 1002 illustrates a SAR image area before DRFM mitigation. As shown, a DRFM interferer located within SAR image area 1002 has an effective DRFM area that covers the entirety of SAR image area 1002 prior to DRFM mitigation. On the other hand, SAR image area 1004 illustrates the same area after DRFM mitigation. As shown, the effective DRFM area of the DRFM interferer is now reduced to a narrow strip within area 1004. Generally, the effective DRFM area is reduced to a cross range strip in the direction of the DRFM interferer.

Further features and advantages of embodiments of the present invention should be apparent to a person skilled in the art based on the teachings herein. In particular, embodiments of the present invention provide an Electronic Counter Counter Measure (ECCM) technique that is effective against, among others, SAR DRFM-based repeater jamming, false target images, noise jamming, and vector multiplier jamming for false scene generation. When used, embodiments of the present invention reduce jammer effectiveness to a small cross range strip in the direction of the jammer. In addition, jammer mitigation is performed without losing SAR image data at the affected SAR pixels. Furthermore, embodiments of the present invention are compatible with time variable ECCM techniques, including orthogonal waveforms or pulse jitter techniques, for example.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for removing interference from radar images, comprising:
(a) receiving a plurality of return signals at multiple phase centers of a radar;
(b) generating a plurality of radar images from said plurality of return signals, respectively;
(c) generating a phase difference image from said plurality of radar images;
(d) generating a plurality of clutter-cancelled radar images using said plurality of radar images and said phase difference image;
(e) generating a clutter-cancelled phase difference image from said plurality of clutter-cancelled radar images; and
(f) generating an interference-free radar image using said plurality of radar images and said clutter-cancelled phase difference image.

2. The method of claim 1, wherein said plurality of return signals are in response to a plurality of received signals from said phase centers of said radar.

3. The method of claim 1, wherein step (c) comprises generating a phase difference image from first and second radar images of said plurality of radar images.

4. The method of claim 3, wherein step (c) comprises generating a phase-interferometry image.

5. The method of claim 4, wherein step (d) comprises:
(i) estimating for each pixel of said phase-interferometry image a corresponding smoothed value of the phase difference for said pixel between said first and second radar images; and
(ii) subtracting for each pixel said second radar image, modified by said corresponding smoothed value, from said first radar image.

6. The method of claim 1, wherein step (d) comprises generating a first clutter-cancelled radar image from first and second radar images of said plurality of radar images, and a second clutter-cancelled radar image from the second radar image and a third radar image of the said plurality of radar images.

7. The method of claim 6, wherein step (e) comprises generating said clutter-cancelled phase difference image from said first and second clutter-cancelled radar images.

8. The method of claim 7, wherein step (f) comprises subtracting said second radar image, modified by said clutter cancelled phase difference image, from said first radar image to generate said interference-free radar image.

9. The method of claim 1, wherein said clutter-cancelled radar images include minimal or no ground return.

10. The method of claim 1, wherein said interference-free radar image includes minimal or no Digital Radio Frequency Memory (DRFM)-based interference.

11. The method of claim 1, further comprising:
(f) detecting jamming by examining phases associated with pixels in said clutter-cancelled radar images.

12. The method of claim 1, wherein in said interference-free radar image jamming effects due to a jammer are reduced to a range strip in the direction of said jammer.

13. The method of claim 1, wherein said radar is a Synthetic Aperture Radar (SAR).

14. A system, comprising:
a radar with a plurality of phase centers that respectively receive a plurality of return signals;
a radar image generation module that generates a plurality of radar images from said plurality of return signals, respectively;
a phase difference determination module that generates a phase difference image from said plurality of radar images; and
a processing module that generates an interference-free radar image from said plurality of radar images and said phase difference image.

15. The system of claim 14, wherein said processing module comprises:
a clutter cancellation module that generates clutter-cancelled radar images using said plurality of radar images and said phase difference image; and
an interference cancellation module that generates said interference-free radar image from said clutter-cancelled radar images and said plurality of radar images.

16. The system of claim 15, wherein said clutter-cancelled radar images includes minimal or no ground return.

17. The system of claim 15, further comprising:
a jamming detection module that examines phases associated with pixels of said clutter-cancelled images to detect jamming.

18. The system of claim 14, wherein said phase difference determination module includes a phase-interferometer.

19. The system of claim 14, wherein said interference-free radar image includes minimal or no Digital Radio Frequency Memory (DRFM)-based interference.

20. The system of claim 14, wherein said radar is a Synthetic Aperture Radar (SAR).
